(19) United States
(12) Patent Application Publication
(10) Pub. No.: US 2009/0310691 A1
(43) Pub. Date: Dec. 17, 2009

(54) METHODS AND SYSTEMS FOR CARRIER FREQUENCY OFFSET ESTIMATION AND CORRECTION OFDM/OFDMA SYSTEMS

(75) Inventors: Jong Ro Park, San Ramon, CA (US); Kyung Sup Han, San Ramon, CA (US); Tae Ryun Chang, Santa Clara, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/137,548

(22) Filed: Jun. 12, 2008

(51) Int. Cl. H04L 27/28

(52) U.S. Cl. 375/260

(57) ABSTRACT

Methods and apparatus for determining an accurate fractional carrier frequency offset (CFO) adjustment in an orthogonal frequency-division multiplexing (OFDM) or orthogonal frequency division multiple access (OFDMA) system in an effort to properly compensate for the actual CFO between a transmitter and a receiver are provided. This enhanced fractional CFO adjustment may be based on a history of estimated fractional CFOs and estimated carrier-to-interference-plus-noise ratios (CINRs) and may be statistically derived from this history, therefore leading to a more accurate fractional CFO adjustment when compared to conventional fractional CFO estimations. A more accurate fractional CFO adjustment may lead to increased physical layer performance and decreased decoding errors (i.e., lower bit error ratio, or BER).

### TECHNICAL FIELD

Certain embodiments of the present disclosure generally relate to wireless communication and, more particularly, to determining a fractional carrier frequency offset (CFO) adjustment in orthogonal frequency-division multiplexing and orthogonal frequency division multiple access (OFDM/OFDMA) systems.

### BACKGROUND

OFDM and OFDMA wireless communication systems under IEEE 802.16x use a network of base stations to communicate with wireless devices (i.e., mobile stations) registered for services in the systems based on the orthogonality of frequencies of multiple subcarriers and can be implemented to achieve a number of technical advantages for wideband wireless communications, such as resistance to multipath fading and interference. Each base station emits and receives radio frequency (RF) signals (where an encoded and processed message signal has been used to modulate a carrier signal having a certain carrier frequency) that convey data to and from the mobile stations.

Ideally, the receive carrier frequency should exactly match the transmit carrier frequency. However, the carrier frequencies between a transmitter (e.g., a base station) and a receiver (e.g., a mobile station) may be slightly different in some cases, leading to a non-zero carrier frequency offset (CFO) in the received OFDM(A) signal. OFDM(A) signals are very susceptible to such CFO, which causes a loss of orthogonality between the OFDM(A) subcarriers and results in inter-carrier interference (ICI) and a severe increase in the bit error ratio (BER) of the recovered data at the receiver. The CFO at the receiver may be divided into an integer portion, which is greater than the subcarrier spacing, and a fractional portion, which is less than the subcarrier spacing. The fractional CFO is typically corrected first in order to properly detect and correct the integer CFO. Accordingly, proper estimation and correction of the fractional CFO is important in order to properly receive an OFDM(A) signal that has been transmitted across a wireless channel and demodulate the symbols from the received signal.

### SUMMARY

Certain embodiments of the present disclosure generally relate to determining an accurate fractional carrier frequency offset (CFO) adjustment in an orthogonal frequency-division multiplexing (OFDM) or orthogonal frequency division multiple access (OFDMA) system in an effort to properly compensate for the CFO between a transmitter and a receiver.

Certain embodiments of the present disclosure provide a method. The method generally includes sampling a plurality of fractional CFO estimates from a plurality of OFDM or OFDMA frames received across a wireless channel and determining an enhanced fractional CFO estimate based on the sampled plurality of fractional CFO estimates.

Certain embodiments of the present disclosure provide a computer-readable medium containing a program for determining an enhanced fractional CFO estimate, which, when executed by a processor, performs certain operations. The operations generally include sampling a plurality of fractional CFO estimates from a plurality of OFDM or OFDMA frames received across a wireless channel and determining an enhanced fractional CFO estimate based on the sampled plurality of fractional CFO estimates.

Certain embodiments of the present disclosure provide a receiver for wireless communication. The receiver generally includes first sampling logic configured to sample a plurality of fractional CFO estimates from a plurality of OFDM or OFDMA frames received across a wireless channel and determination logic configured to determine an enhanced fractional CFO estimate based on the sampled plurality of fractional CFO estimates.

Certain embodiments of the present disclosure provide an apparatus for wireless communication. The apparatus generally includes means for sampling a plurality of fractional CFO estimates from a plurality of OFDM or OFDMA frames received across a wireless channel and means for determining an enhanced fractional CFO estimate based on the sampled plurality of fractional CFO estimates.

Certain embodiments of the present disclosure provide a mobile device. The mobile device generally includes a receiver front end for receiving a signal transmitted via a wireless channel, sampling logic configured to sample a plurality of fractional CFO estimates from a plurality of OFDM or OFDMA frames received across the wireless channel, and determination logic configured to determine an enhanced fractional CFO estimate based on the sampled plurality of fractional CFO estimates.

### BRIEF DESCRIPTION OF THE DRAWINGS

So that the manner in which the above recited features of the present disclosure can be understood in detail, a more particular description, briefly summarized above, may be had by reference to embodiments, some of which are illustrated in the appended drawings. It is to be noted, however, that the appended drawings illustrate only certain typical embodiments of this disclosure and are therefore not to be considered limiting of its scope, for the description may admit to other equally effective embodiments.

FIG. 1 illustrates an example wireless communication system, in accordance with certain embodiments of the present disclosure.

FIG. 2 illustrates various components that may be utilized in a wireless device, in accordance with certain embodiments of the present disclosure.

FIG. 3 illustrates an example transmitter and an example receiver that may be used within a wireless communication system that utilizes orthogonal frequency-division multiplexing and orthogonal frequency division multiple access (OFDM/OFDMA) technology, in accordance with certain embodiments of the present disclosure.

FIG. 4 illustrates an example OFDM(A) frame for Time Division Duplex (TDD), in accordance with certain embodiments of the present disclosure.

FIG. 5 illustrates an example receiver with signal processing including fractional carrier frequency offset (CFO) estimation and carrier-to-interference-plus-noise ratio (CINR) estimation, in accordance with certain embodiments of the present disclosure.

FIG. 6 is a flow chart of example operations for determining an enhanced fractional CFO estimate based on the estimated CINRs and estimated fractional CFOs, in accordance with certain embodiments of the present disclosure.

FIG. 6A is a block diagram of means corresponding to the example operations of FIG. 6 for determining the enhanced fractional CFO estimate, in accordance with certain embodiments of the present disclosure.

FIG. 7 illustrates interval options in units of OFDM(A) frames for sampling the fractional CFO in an effort to determine an accurate estimated fractional CFO, in accordance with certain embodiments of the present disclosure.

FIG. 8 illustrates sample count options in units of sampling intervals for sampling the fractional CFO in an effort to determine an accurate estimated fractional CFO, in accordance with certain embodiments of the present disclosure.

FIG. 9 illustrates estimation options for determining an accurate estimated fractional CFO based on stored fractional CFO values and stored CINRs, in accordance with certain embodiments of the present disclosure.

### DETAILED DESCRIPTION

Certain embodiments of the present disclosure provide techniques and apparatus for determining an accurate fractional carrier frequency offset (CFO) adjustment in an orthogonal frequency-division multiplexing (OFDM) or orthogonal frequency division multiple access (OFDMA) system such that the fractional CFO adjustment may be used in an effort to properly compensate for the actual CFO between a transmitter and a receiver. This enhanced fractional CFO adjustment may be based on a history of estimated fractional CFOs and estimated carrier-to-interference-plus-noise ratios (CINRs) and may be statistically derived from this history, therefore leading to a more accurate fractional CFO adjustment when compared to conventional fractional CFO estimations. A more accurate fractional CFO adjustment may lead to increased physical layer performance and decreased decoding errors (i.e., lower bit error ratio, or BER).

### Exemplary Wireless Communication System

The methods and apparatus of the present disclosure may be utilized in a broadband wireless communication system. The term “broadband wireless” refers to technology that provides wireless, voice, Internet, and/or data network access over a given area.

WiMAX, which stands for the Worldwide Interoperability for Microwave Access, is a standards-based broadband wireless technology that provides high-throughput broadband connections over long distances. There are two main applications of WiMAX today: fixed WiMAX and mobile WiMAX. Fixed WiMAX applications are point-to-multipoint, enabling broadband access to homes and businesses, for example. Mobile WiMAX offers the full mobility of cellular networks at broadband speeds.

Mobile WiMAX is based on OFDM (orthogonal frequency-division multiplexing) and OFDMA (orthogonal frequency division multiple access) technology. OFDM is a digital multi-carrier modulation technique that has recently found wide adoption in a variety of high-data-rate communication systems. With OFDM, a transmit bit stream is divided into multiple lower-rate substreams. Each substream is modulated with one of multiple orthogonal subcarriers and sent over one of a plurality of parallel subchannels. OFDMA is a multiple access technique in which users are assigned subcarriers in different time slots. OFDMA is a flexible multiple-access technique that can accommodate many users with widely varying applications, data rates, and quality of service requirements.

The rapid growth in wireless internets and communications has led to an increasing demand for high data rate in the field of wireless communications services. OFDM/OFDMA systems are today regarded as one of the most promising research areas and as a key technology for the next generation of wireless communications. This is due to the fact that OFDM/OFDMA modulation schemes can provide many advantages such as modulation efficiency, spectrum efficiency, flexibility, and strong multipath immunity over conventional single carrier modulation schemes.

IEEE 802.16x is an emerging standard organization to define an air interface for fixed and mobile broadband wireless access (BWA) systems, such as for fixed BWA systems and for mobile BWA systems. These standards define at least four different physical layers (PHYs) and one media access control (MAC) layer. The OFDM and OFDMA physical layer of the four physical layers are the most popular in the fixed and mobile BWA areas, respectively.

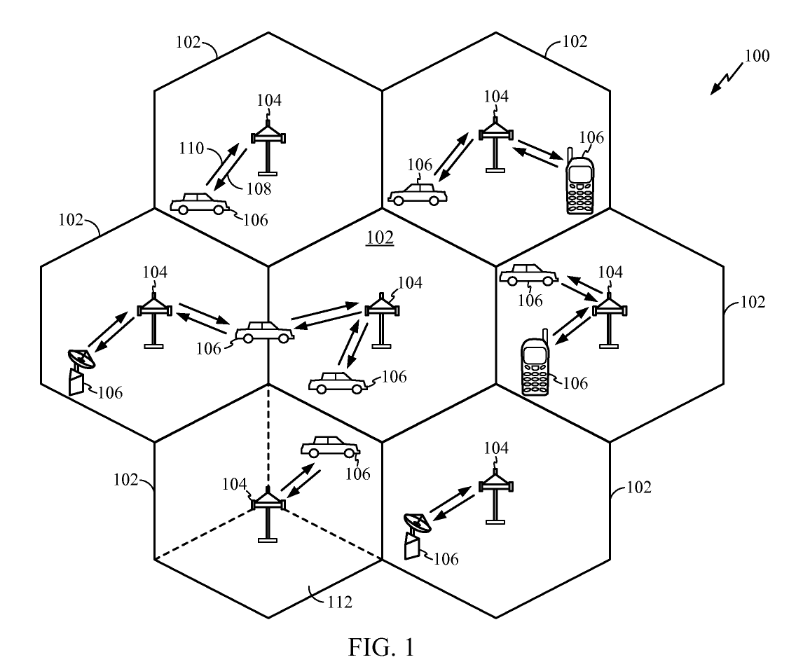

FIG. 1 illustrates an example of a wireless communication system 100. The wireless communication system 100 may be a broadband wireless communication system. The wireless communication system 100 may provide communication for a number of cells 102, each of which is serviced by a base station 104. A base station 104 may be a fixed station that communicates with user terminals 106. The base station 104 may alternatively be referred to as an access point, a Node B, or some other terminology.

FIG. 1 depicts various user terminals 106 dispersed throughout the system 100. The user terminals 106 may be fixed (i.e., stationary) or mobile. The user terminals 106 may alternatively be referred to as remote stations, access terminals, terminals, subscriber units, mobile stations, stations, user equipment, etc. The user terminals 106 may be wireless devices, such as cellular phones, personal digital assistants (PDAs), handheld devices, wireless modems, laptop computers, personal computers, etc.

A variety of algorithms and methods may be used for transmissions in the wireless communication system 100 between the base stations 104 and the user terminals 106. For example, signals may be sent and received between the base stations 104 and the user terminals 106 in accordance with OFDM/OFDMA techniques. If this is the case, the wireless communication system 100 may be referred to as an OFDM/OFDMA system.

A communication link that facilitates transmission from a base station 104 to a user terminal 106 may be referred to as a downlink 108, and a communication link that facilitates transmission from a user terminal 106 to a base station 104 may be referred to as an uplink 110. Alternatively, a downlink 108 may be referred to as a forward link or a forward channel, and an uplink 110 may be referred to as a reverse link or a reverse channel.

A cell 102 may be divided into multiple sectors 112. A sector 112 is a physical coverage area within a cell 102. Base stations 104 within a wireless communication system 100 may utilize antennas that concentrate the flow of power within a particular sector 112 of the cell 102. Such antennas may be referred to as directional antennas.

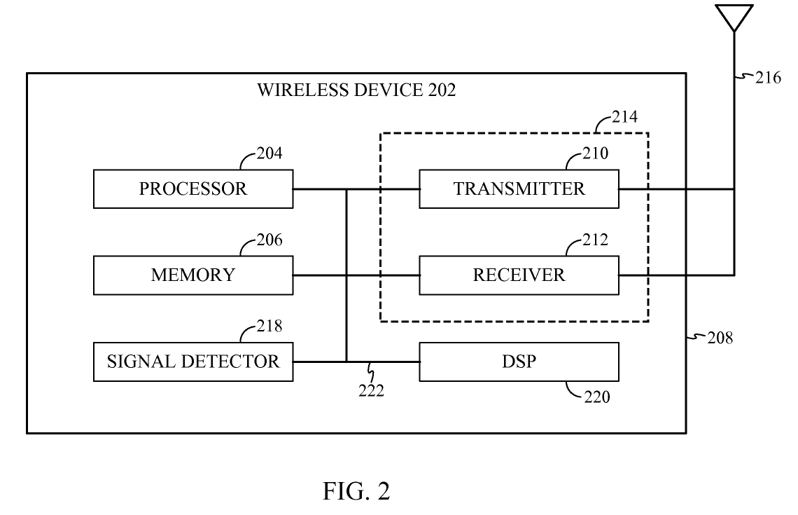

FIG. 2 illustrates various components that may be utilized in a wireless device 202. The wireless device 202 is an example of a device that may be configured to implement the various methods described herein. The wireless device 202 may be a base station 104 or a user terminal 106.

The wireless device 202 may include a processor 204 which controls operation of the wireless device 202. The processor 204 may also be referred to as a central processing unit (CPU). Memory 206, which may include both read-only memory (ROM) and random access memory (RAM), provides instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The wireless device 202 may also include a housing 208 that may include a transmitter 210 and a receiver 212 to allow transmission and reception of data between the wireless device 202 and a remote location. The transmitter 210 and receiver 212 may be combined into a transceiver 214. An antenna 216 may be attached to the housing 208 and electrically coupled to the transceiver 214. The wireless device 202 may also include (not shown) multiple transmitters, multiple receivers, multiple transceivers, and/or multiple antennas.

The wireless device 202 may also include a signal detector 218 that may be used in an effort to detect and quantify the level of signals received by the transceiver 214. The signal detector 218 may detect such signals as total energy, pilot energy per pseudonoise (PN) chips, power spectral density, and other signals. The wireless device 202 may also include a digital signal processor (DSP) 220 for use in processing signals.

The various components of the wireless device 202 may be coupled together by a bus system 222, which may include a power bus, a control signal bus, and a status signal bus in addition to a data bus.

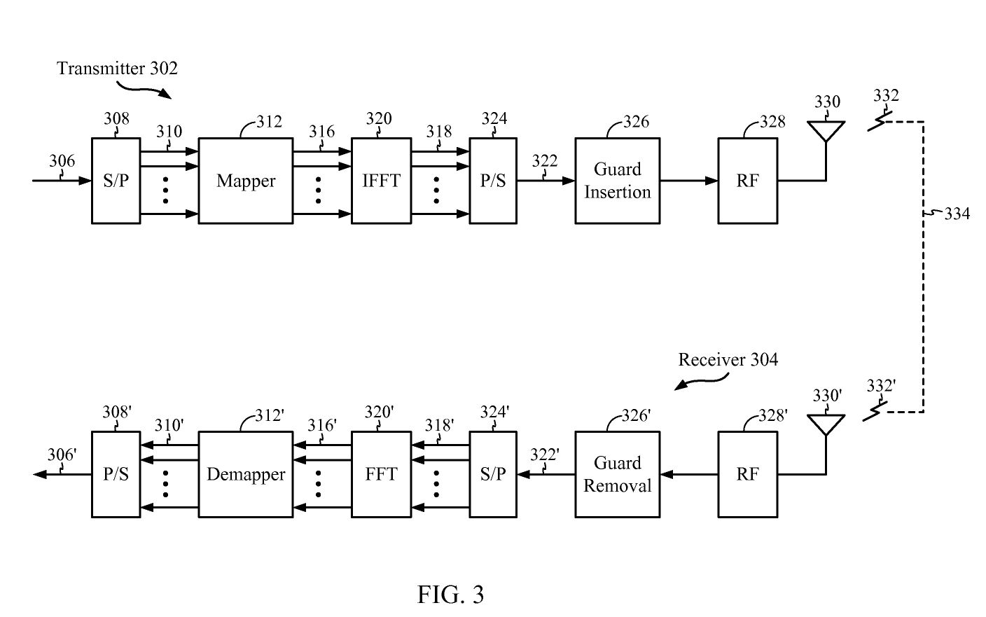

FIG. 3 illustrates an example of a transmitter 302 that may be used within a wireless communication system 100 that utilizes OFDM/OFDMA. Portions of the transmitter 302 may be implemented in the transmitter 210 of a wireless device 202. The transmitter 302 may be implemented in a base station 104 for transmitting data 306 to a user terminal 106 on a downlink 108. The transmitter 302 may also be implemented in a user terminal 106 for transmitting data 306 to a base station 104 on an uplink 110.

Data 306 to be transmitted is shown being provided as input to a serial-to-parallel (S/P) converter 308. The S/P converter 308 may split the transmission data into N parallel data streams 310.

The N parallel data streams 310 may then be provided as input to a mapper 312. The mapper 312 may map the N parallel data streams 310 onto N constellation points. The mapping may be done using some modulation constellation, such as binary phase-shift keying (BPSK), quadrature phase-shift keying (QPSK), 8 phase-shift keying (8PSK), quadrature amplitude modulation (QAM), etc. Thus, the mapper 312 may output N parallel symbol streams 316, each symbol stream 316 corresponding to one of the N orthogonal subcarriers of the inverse fast Fourier transform (IFFT) 320. These N parallel symbol streams 316 are represented in the frequency domain and may be converted into N parallel time domain sample streams 318 by an IFFT component 320.

A brief note about terminology will now be provided. N parallel modulations in the frequency domain are equal to N modulation symbols in the frequency domain, which are equal to N mapping and N-point IFFT in the frequency domain, which is equal to one (useful) OFDM symbol in the time domain, which is equal to N samples in the time domain. One OFDM symbol in the time domain, Nₛ, is equal to N_{cp} (the number of guard samples per OFDM symbol)+N (the number of useful samples per OFDM symbol).

The N parallel time domain sample streams 318 may be converted into an OFDM/OFDMA symbol stream 322 by a parallel-to-serial (P/S) converter 324. A guard insertion component 326 may insert a guard interval between successive OFDM/OFDMA symbols in the OFDM/OFDMA symbol stream 322. The output of the guard insertion component 326 may then be upconverted to a desired transmit frequency band by a radio frequency (RF) front end 328. An antenna 330 may then transmit the resulting signal 332.

FIG. 3 also illustrates an example of a receiver 304 that may be used within a wireless communication system 100 that utilizes OFDM/OFDMA. Portions of the receiver 304 may be implemented in the receiver 212 of a wireless device 202. The receiver 304 may be implemented in a user terminal 106 for receiving data 306 from a base station 104 on a downlink 108. The receiver 304 may also be implemented in a base station 104 for receiving data 306 from a user terminal 106 on an uplink 110.

The transmitted signal 332 is shown traveling over a wireless channel 334. When a signal 332′ is received by an antenna 330′, the received signal 332′ may be downconverted to a baseband signal by an RF front end 328′. A guard removal component 326′ may then remove the guard interval, or cyclic prefix (CP), that was inserted between OFDM/OFDMA symbols by the guard insertion component 326.

The output of the guard removal component 326′ may be provided to an S/P converter 324′. The S/P converter 324′ may divide the OFDM/OFDMA symbol stream 322′ into the N parallel time-domain symbol streams 318′, each of which corresponds to one of the N orthogonal subcarriers. A fast Fourier transform (FFT) component 320′ may convert the N parallel time-domain symbol streams 318′ into the frequency domain and output N parallel frequency-domain symbol streams 316′.

A demapper 312′ may perform the inverse of the symbol mapping operation that was performed by the mapper 312, thereby outputting N parallel data streams 310′. A P/S converter 308′ may combine the N parallel data streams 310′ into a single data stream 306′. Ideally, this data stream 306′ corresponds to the data 306 that was provided as input to the transmitter 302.

### Exemplary OFDM(A) Frame

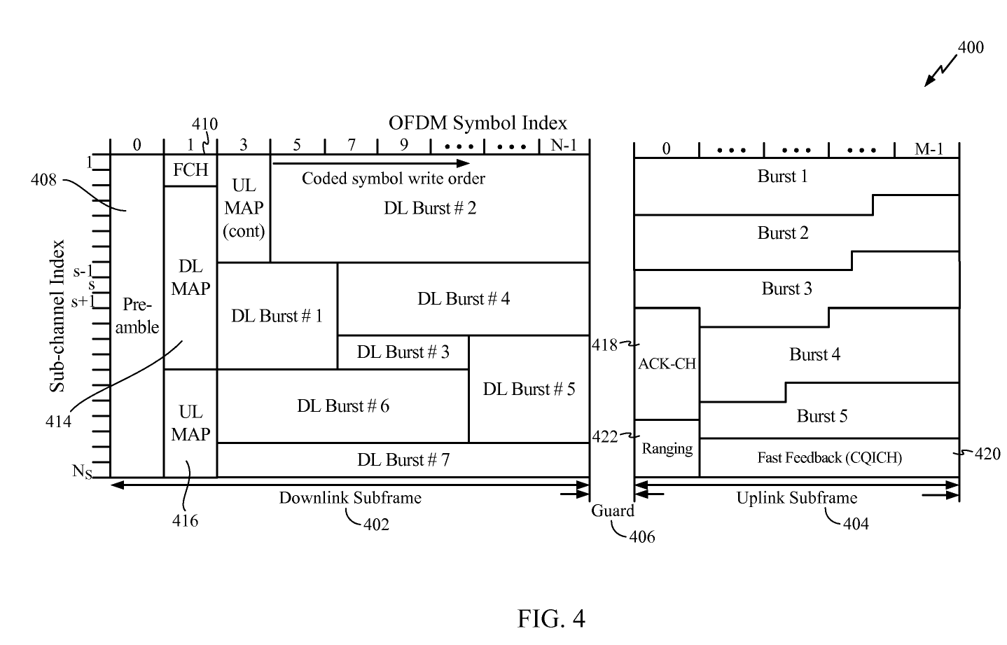

Referring now to FIG. 4, an OFDM(A) frame 400 for a Time Division Duplex (TDD) implementation is depicted as a typical, but not limiting, example. Other implementations of an OFDM(A) frame, such as Full and Half-Duplex Frequency Division Duplex (FDD) may be used, in which case the frame is the same except that both downlink (DL) and uplink (UL) are transmitted simultaneously over different carriers. In the TDD implementation, each frame may be divided into a DL subframe 402 and a UL subframe 404, which may be separated by a small guard interval 406—or, more specifically, by Transmit/Receive and Receive/Transmit Transition Gaps (TTG and RTG, respectively)—in an effort to prevent DL and UL transmission collisions. The DL-to-UL-subframe ratio may be varied from 3:1 to 1:1 to support different traffic profiles.

Within the OFDM(A) frame 400, various control information may be included. For example, the first OFDM(A) symbol of the frame 400 may be a preamble 408, which may contain several pilot signals (pilots) used for synchronization. Fixed pilot sequences inside the preamble 408 may allow the receiver 304 to estimate frequency and phase errors and to synchronize to the transmitter 302. Moreover, fixed pilot sequences in the preamble 408 may be utilized to estimate and equalize wireless channels. The preamble 408 may contain BPSK-modulated carriers and is typically one OFDM symbol long. The carriers of the preamble 408 may be power boosted and are typically a few decibels (dB) (e.g., 9 dB) higher than the power level in the frequency domain of data portions in the WiMAX signal. The number of preamble carriers used may indicate which of the three segments of the zone are used. For example, carriers 0, 3, 6, . . . may indicate that segment 0 is to be used, carriers 1, 4, 7, . . . may indicate that segment 1 is to be used, and carriers 2, 5, 8, . . . may indicate that segment 3 is to be used.

A Frame Control Header (FCH) 410 may follow the preamble 408. The FCH 410 may provide frame configuration information, such as the usable subchannels, the modulation and coding scheme, and the Media Access Protocol (MAP) message length for the current OFDM(A) frame. A data structure, such as the downlink Frame Prefix (DLFP), outlining the frame configuration information may be mapped to the FCH 410. For Mobile WiMAX, the DLFP may comprise six bits for the used subchannel (SCH) bitmap, a reserved bit set to 0, two bits for the repetition coding indication, three bits for the coding indication, eight bits for the Media Access Protocol (MAP) message length, and four reserved bits set to 0 for a total of 24 bits in the DLFP. Before being mapped to the FCH 410, the 24-bit DLFP may be duplicated to form a 48-bit block, which is the minimal forward error correction (FEC) block size.

Following the FCH 410, a DL MAP 414 and a UL MAP 416 may specify subchannel allocation and other control information for the DL and UL subframes 402, 404. In the case of OFDMA, multiple users may be allocated data regions within the frame, and these allocations may be specified in the DL and UL MAP messages 414, 416. The MAP messages may include the burst profile for each user, which defines the modulation and coding scheme used in a particular link. The DL subframe 402 of the OFDM(A) frame may include DL bursts of various bit lengths containing the downlink data being communicated. Thus, the DL MAP 414 may describe the location of the bursts contained in the downlink zones and the number of downlink bursts, as well as their offsets and lengths in both the time (i.e., symbol) and the frequency (i.e., subchannel) directions.

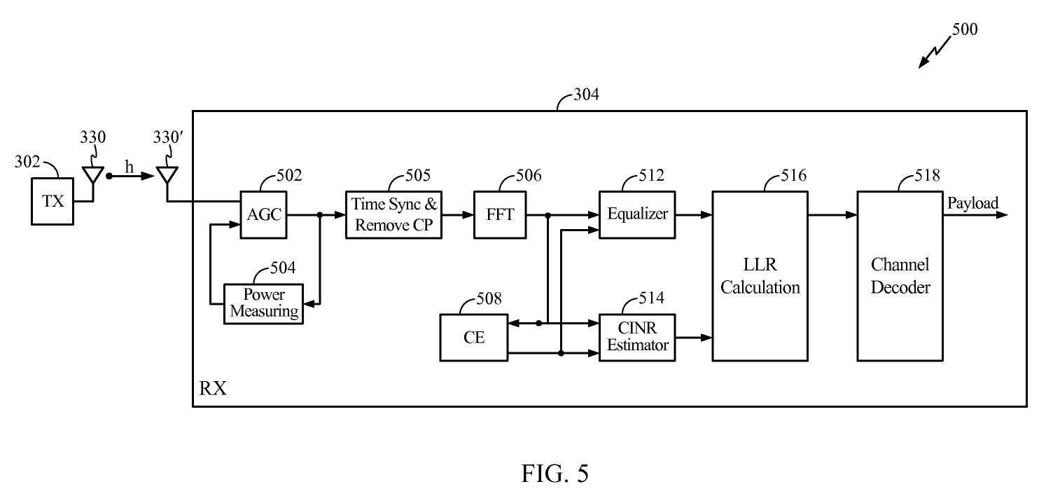

Likewise, the UL subframe 404 may include UL bursts of various bit lengths composed of the uplink data being communicated. Therefore, the UL MAP 416, transmitted as the first burst in the downlink subframe 402, may contain information about the location of the UL burst for different users. The UL subframe 504 may include additional control information as illustrated in FIG. 5. The UL subframe 404 may include a UL ACK 418 allocated for the mobile station (MS) to feed back a DL hybrid automatic repeat request acknowledge (HARQ ACK) and/or a UL CQICH 420 allocated for the MS to feed back channel state information on the Channel Quality Indicator channel (CQICH). Furthermore, the UL subframe 404 may comprise a UL Ranging subchannel 422. The UL Ranging subchannel 422 may be allocated for the MS to perform closed-loop time, frequency, and power adjustment, as well as bandwidth requests. Altogether, the preamble 408, the FCH 410, the DL MAP 414, and the UL MAP 416 may carry information that enables the receiver 304 to correctly demodulate the received signal.

For OFDMA, different “modes” can be used for transmission in DL and UL. An area in the time domain where a certain mode is used is generally referred to as a zone. One type of zone is called DL-PUSC (downlink partial usage of subchannels) and does not use all the subchannels available to it (i.e., a DL-PUSC zone only uses particular groups of subchannels). There may be a total of six subchannel groups, which can be assigned to up to three segments. Thus, a segment can contain one to six subchannel groups (e.g., segment 0 contains three subchannel groups, segment 1 contains two, and segment 2 contains one subchannel group). Another type of zone is called DL-FUSC (downlink full usage of subchannels). Unlike DL-PUSC, DL-FUSC does not use any segments, but can distribute all bursts over the complete frequency range.

### Exemplary Fraction CFO AND CINR Estimation

Referring now to FIG. 5, a block diagram 500 for a receiver 304 with signal processing including fractional carrier frequency offset (CFO) estimation and carrier-to-interference-plus-noise ratio (CINR) estimation is illustrated. The antenna 330′ of the receiver 304 may receive a message sent from the antenna 330 of a transmitter 302 across a wireless channel h. The radio frequency (RF) front end of the receiver 304 may include an automatic gain control (AGC) circuit 502 for varying the gain of the received signal such that all signals at the output of the AGC circuit 502 may have the same amplitude. As feedback and control for the AGC circuit 502, the RF front end may contain a power measuring circuit 404 to measure power of the gain-controlled signals from the output of the AGC circuit 502.

The receiver 304 may comprise a time synchronization block 505, which may also remove the cyclic prefix (CP), or the guard interval, from the OFDM/OFDMA symbols. Purposes of the time synchronization block 505 may include acquiring frame and symbol timings and identifying the fast Fourier transform (FFT) size and the CP length. Another operation performed in the time synchronization block 505 may involve time domain fractional CFO estimation, which may be performed on an individual OFDM/OFDMA symbol basis. Fractional CFO estimation may be accomplished by using the average phase progression of a replicated set of time-domain OFDM samples (e.g., the repeated cyclic prefix of the same OFDM symbol) or by any other suitable means known those skilled in the art. In an effort to reduce estimation error for some embodiments, the fractional CFO estimation used to compensate for the actual CFO between the receiver 304 and the transmitter 302 may comprise an average of the estimated CFO from multiple symbols, such as an average of the estimated CFO for the preamble 408, the FCH 410, the DL MAP 414, and the UL MAP 416. Once the fractional CFO has been estimated in the time synchronization block 505, the fractional CFO correction may then be applied to the received signal, and for some embodiments, the fractional CFO estimation used for the correction may be stored.

The receiver 304 may also include an FFT block 506 for transforming the fractional-CFO-corrected received signal from the time domain into the frequency domain. The output of the FFT block 506 may be sent to channel estimation (CE) logic 508, which may estimate the channel for corresponding subcarriers and symbols. The output of the CE logic 508 may be a Fourier transform of the channel h. The output of the FFT block 506 and the output of the CE logic 508 may be sent to an equalizer 512 in an effort to remove the effects of the channel h from the received signal.

The output of the FFT block 506 and the output of the CE logic 508 may also be sent to a carrier-to-interference-plus-noise ratio (CINR) estimator 514. The CINR estimator 514 may estimate the signal power, the interference power, the noise power, and/or the CINR for the received signal and/or the estimated channel. For some embodiments, the CINR for the received signal may be stored.

The equalized signal output from the equalizer 512 and the CINR from the CINR estimator 514 may be input to a log likelihood ratio (LLR) calculation block 516. In the LLR calculation block 516, the LLR is calculated per encoded bit using the equalized signal, the CINR, and the modulation type. For QAM64 modulation, for example, 6 LLRs for 6 encoded bits may be calculated, and 2 LLRs for 2 encoded bits may be calculated for the example of QPSK modulation. The LLRs may be sent from the LLR calculation block 416 to the channel decoder 518, which may decode the demapped bits and output an interpreted message.

### Exemplary Enhanced Fractional CFO Adjustment

Once hardware, such as the receiver 304 of FIG. 5, has estimated the fractional CFO on a per symbol or per OFDM(A) frame basis for a number of received OFDM(A) frames, a history of fractional CFO estimations and CINR estimations may be stored in memory or on any other suitable computer-readable medium. Software or firmware may examine this history and statistically derive an enhanced fractional CFO estimation and a corresponding adjustment in an effort to more accurately correct for the actual fractional CFO between the transmitter 302 and the receiver 304. In this hybrid method of fractional CFO estimation and adjustment, the adjustment according to the enhanced fractional CFO estimation as determined by the more flexible software or firmware may be implemented on individual symbols.

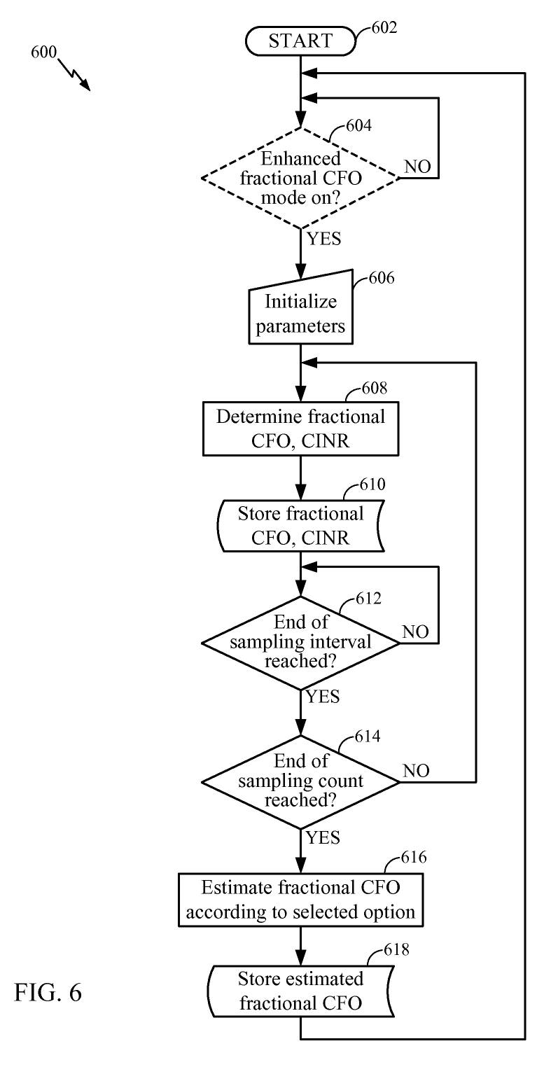

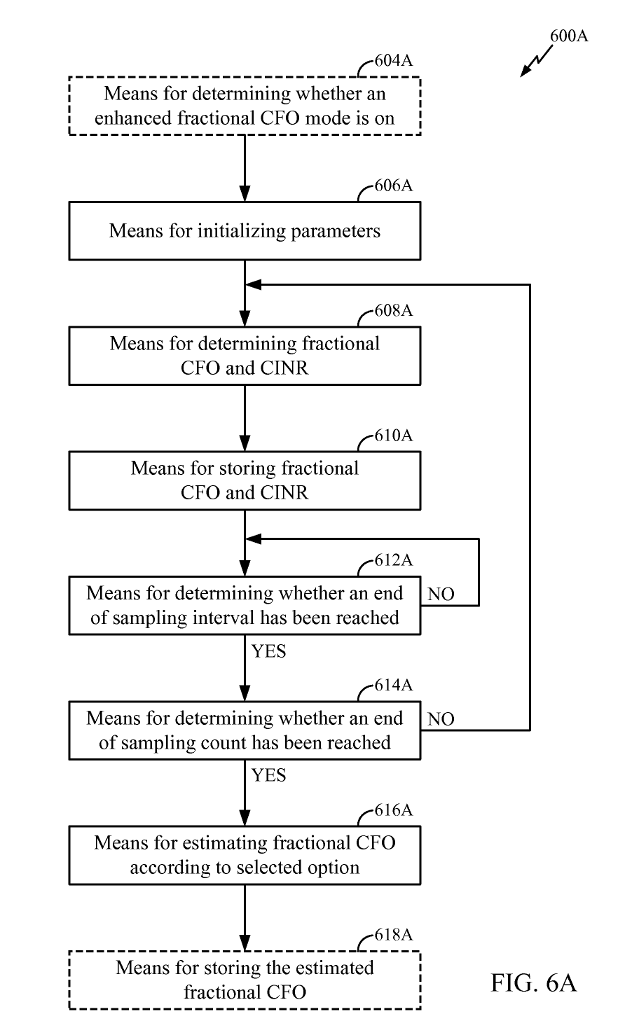

FIG. 6 illustrates a flow diagram of example operations 600 for determining an enhanced fractional CFO adjustment based on the estimated CINRs and the estimated fractional CFOs. The operations may begin, at 602. For some embodiments where the enhanced fractional CFO mode may be toggled between being enabled and disabled, a decision may be made at 604 whether the enhanced fractional CFO mode has been enabled. If the mode has been disabled, then the operations 600 may not continue until the mode has been enabled. For embodiments that always have the enhanced fractional CFO mode enabled, optional block 604 may be skipped altogether. At 606, one or more parameters for determining the enhanced fractional CFO may be initialized. These parameters may be entered, may be predetermined and stored, or may be selected from a table of predetermined values.

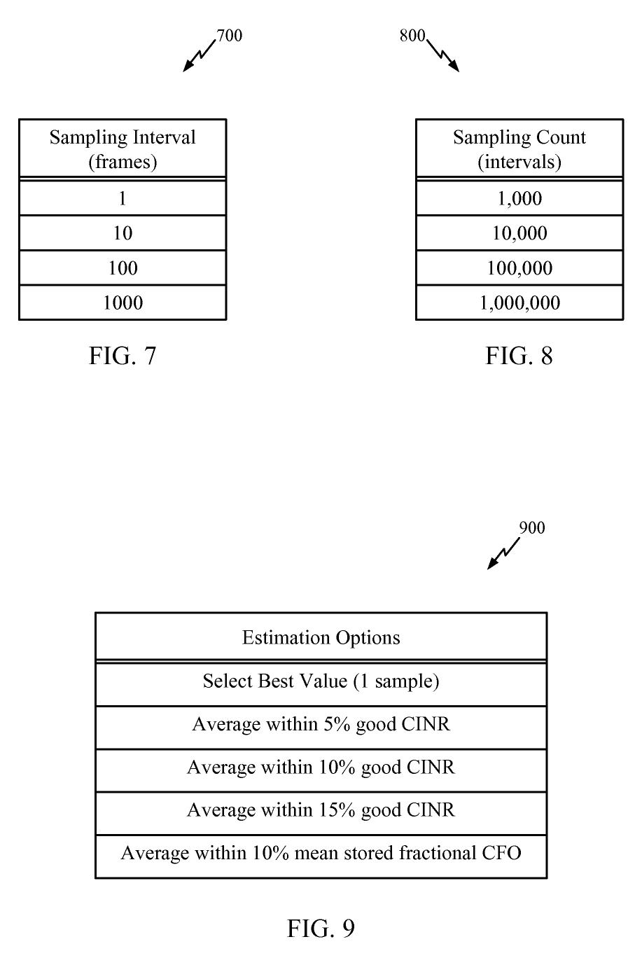

One of these parameters may be the sampling interval, which controls how often the fractional CFO estimation and the CINR estimation are stored for evaluation. FIG. 7 illustrates a table 700 of possible sampling interval values in units of OFDM(A) frames. The first row of the table 700 indicates that the estimated CINR and fractional CFO will be stored every single frame, and the last row indicates that these estimates will be stored once every thousand frames. The table 700 may be expanded to include one or more additional rows with alternative sampling interval values or may be reduced to remove one or more rows.

Another parameter initialized at 606 may be the sampling count, which dictates how many samples of estimated CINR and fractional CFO should be stored before the samples are evaluated. FIG. 8 illustrates a table 800 of possible sampling count values in units of sampling intervals. The first row of the table 800 indicates that one thousand samples of each of the estimated CINR and fractional CFO will be stored for evaluation, and the last row indicates that one million samples of each of these estimates will be stored, each sample taken at the initialized sampling interval. The table 800 may be expanded to include one or more additional rows with alternative sampling count values or may be reduced to remove one or more rows. If software or firmware collects too many samples, there may be too much overhead involved in determining an enhanced fractional CFO. Thus, the sampling count value may be dictated by the system capability and/or the desired accuracy.

Yet another parameter initialized at 606 may be an estimation option, which determines how the enhanced fractional CFO may be calculated from the stored fractional CFO and CINR estimates. The assumption behind most of these estimation options is that the CINR typically increases when the fractional CFO estimate is correct, but decreases when the estimate is not a good fractional CFO estimate. Also, since the transmitter 302 may employ two different coding methods when encoding the preamble and the FCH versus encoding the data bursts, a big difference in the CINR estimates for bursts encoded with two different methods may also indicate a defective fractional CFO estimate.

FIG. 9 illustrates a table 900 of possible estimation options for statistically deriving the enhanced fractional CFO. The first row of the table 900 indicates that the stored fractional CFO estimate corresponding to the best value (i.e., the highest stored CINR estimate) may be selected as the enhanced fractional CFO estimate. For some embodiments, the best value or the stored fractional CFO corresponding to the best value may be evaluated to determine whether it is a statistical outlier and should therefore probably not be used. In such cases, another stored fractional CFO estimate corresponding to a second or other best value may be selected instead. The second through fourth rows of the table 900 indicate that the stored fractional CFO estimates corresponding to CINR estimates within a certain percentage (e.g., 5%, 10%, or 15%) of the highest stored CINR estimate may be selected as a subset, and the enhanced fractional CFO estimate may be calculated as the average of this subset of stored fractional CFO estimates. The last row of the table 900 indicates that the mean of all of the stored fractional CFO estimates will be calculated, the stored fractional CFO estimates within 10% of the mean may be selected as a subset, and the enhanced fractional CFO estimate may be calculated as the average of this subset. Those skilled in the art may recognize that different percentages may be available as options in the table 900 or that the subsets may be based on standard deviation or confidence. Furthermore, the table 900 may be expanded to include one or more additional rows with alternative estimation options or may be reduced to remove one or more rows.

Referring again to FIG. 6, once the parameters have been initialized at 606, the fractional CFO estimate and the CINR estimate may be determined and read, perhaps at the end of the reception and decoding of an OFDM(A) frame. The fractional CFO and CINR estimates for the OFDM(A) frame may be stored at 610. The fractional CFO estimate and the CINR estimate may be stored in two separate registers, both with read-only access. For some embodiments, the fractional CFO estimate of the current OFDM(A) frame may be stored in a 15-bit register as a signed number. Also for some embodiments, the CINR estimate(s) may be stored in a 16-bit register as a signed number, bits 15-8 containing the CINR estimate of the last burst and bits 7-0 containing the CINR estimate of the DL MAP 414.

If the end of the set sampling interval has not been reached at 612, then OFDM(A) frames may continue to be received and decoded without storing the fractional CFO and CINR estimates until the end of the sampling interval has been reached. Once the number of frames in the sampling interval have been received and decoded, if the end of the set sampling count has not been reached at 614, then the operations may repeat at 608 until enough fractional CFO and CINR estimates have been stored according to the sampling count. Thus, if the selected sampling interval is once every 10 frames and the selected sampling count is 1000 intervals, then 10*1000=10,000 OFDM(A) frames will be received before an enhanced fractional CFO is determined, but fractional CFO and CINR estimates for only 1000 frames out of the 10,000 will be stored for evaluation.

Once the end of the sampling count has been reached at 614, then the enhanced fractional CFO may be estimated at 616 according to the estimation option selected at 606. For example, the stored fractional CFO estimate corresponding to the highest CINR estimate may be designated as the enhanced fractional CFO estimate, or an average of the stored fractional CFO estimates corresponding to the CINR estimates within a certain percentage of the highest CINR estimate may be designated as the enhanced fractional CFO estimate. Because the enhanced fractional CFO estimate is based on a larger sample and is statistically derived, the enhanced fractional CFO estimate may be more accurate (i.e., is closer to the actual fractional CFO between the transmitter 302 and receiver 304) than at least the majority of the stored fractional CFO estimates. With a more accurate fractional CFO estimate, the physical layer performance of OFDM/OFDMA systems may be increased, and decoding errors may be reduced (i.e., the bit error ratio, or BER, may be decreased).

The enhanced fractional CFO estimate (or an adjustment value corresponding to the enhanced fractional CFO estimate) may be stored at 618. The enhanced fractional CFO estimate may be stored in a register with read and write access. For some embodiments, this register may be a 16-bit register, where the most significant bit (MSB) indicates whether the enhanced mode is enabled and the other 15 bits contain the enhanced fractional CFO estimate (or the corresponding adjustment value) stored as a signed number. The stored value may be employed in an effort to compensate for the actual fractional CFO between the transmitter 302 and receiver 304. The hardware, such as the RF front end 328′ or the time synchronization block 505 of the receiver 304, may implement the adjustment based on the enhanced fractional CFO estimate as determined by the software or firmware.

After the enhanced fractional CFO estimate (or the corresponding adjustment value) has been stored at 618, the operations 600 may repeat beginning at optional block 604 or at 606. In this manner, the software or firmware may continuously determine an accurate fractional CFO. For some embodiments, repeating the operations 600 may be decided based on one or more criteria. For example, a CINR comparison may be performed between signals with same received signal strength indication (RSSI) value, between a preamble signal and a normal data burst signal, and between signals from different zones. When the CINR decreases, the software or firmware may decide to repeat the operations 600 since it is likely that the current enhanced fractional CFO value is now obsolete and incorrect.

The operations 600 of FIG. 6 described above may be performed by various hardware and/or software component(s) and/or module(s) corresponding to the means-plus-function blocks 600A illustrated in FIG. 6A. In other words, blocks 604 through 618 illustrated in FIG. 6 correspond to means-plus-function blocks 604A through 618A illustrated in FIG. 6A.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

Information and signals may be represented using any of a variety of different technologies and techniques. For example, data, instructions, commands, information, signals and the like that may be referenced throughout the above description may be represented by voltages, currents, electromagnetic waves, magnetic fields or particles, optical fields or particles or any combination thereof.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in software, the functions may be stored as instructions or one or more sets of instructions on a computer-readable medium or storage medium. A storage media may be any available media that can be accessed by a computer or one or more processing devices. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method comprising:
sampling a plurality of fractional carrier frequency offset (CFO) estimates from a plurality of orthogonal frequency-division multiplexing (OFDM) or orthogonal frequency division multiple access (OFDMA) frames received across a wireless channel; and
determining an enhanced fractional CFO estimate based on the sampled plurality of fractional CFO estimates.

2. The method of claim 1, further comprising:
sampling a plurality of carrier-to-interference-plus-noise ratio (CINR) estimates corresponding to the sampled plurality of fractional CFO estimates; and
determining the enhanced fractional CFO estimate based on the sampled plurality of fractional CFO estimates and the corresponding sampled plurality of CINR estimates.

3. The method of claim 2, wherein determining the enhanced fractional CFO estimate comprises selecting one of the sampled plurality of fractional CFO estimates corresponding to the highest CINR estimate of the sampled plurality of CINR estimates

4. The method of claim 2, wherein determining the enhanced fractional CFO estimate comprises:
selecting a portion of the sampled plurality of fractional CFO estimates corresponding to a portion of the sampled plurality of CINR estimates within a percentage of the highest CINR estimate of the sampled plurality of CINR estimates; and
averaging the selected portion of the sampled plurality of fractional CFO estimates to be the enhanced fractional CFO estimate.

5. The method of claim 4, wherein the percentage is 5%, 10%, or 15%.

6. The method of claim 1, wherein determining the enhanced fractional CFO estimate comprises:
averaging the sampled plurality of fractional CFO estimates to determine a mean;
selecting a portion of the sampled plurality of fractional CFO estimates within a percentage of the mean; and
averaging the selected portion of the sampled plurality of fractional CFO estimates to be the enhanced fractional CFO estimate.

7. The method of claim 6, wherein the percentage is 10%.

8. The method of claim 1, wherein sampling the plurality of fractional CFO estimates comprises:
(a) storing one fractional CFO estimate of an OFDM or OFDMA frame to the sampled plurality of fractional CFO estimates per number of OFDM or OFDMA frames in a sampling interval; and
(b) repeating step (a) for a number of sampling intervals in a sampling count.

9. The method of claim 8, wherein the sampling interval is 1, 10, 100, or 1000 OFDM or OFDMA frames.

10. The method of claim 8, wherein the sampling count is 10³, 10⁴, 10⁵, or 10⁶.

11. The method of claim 1, wherein each of the plurality of fractional CFO estimates was determined based on a cyclic prefix (CP) of a symbol of one of the plurality of OFDM or OFDMA frames.

12. The method of claim 1, further comprising storing the enhanced fractional CFO estimate in a register.

13. The method of claim 1, further comprising adjusting a signal received across the wireless channel based on the enhanced fractional CFO estimate.

14. A computer-readable medium containing a program for determining an enhanced fractional carrier frequency offset (CFO) estimate, which, when executed by a processor, performs operations comprising:
sampling a plurality of fractional carrier frequency offset (CFO) estimates from a plurality of orthogonal frequency-division multiplexing (OFDM) or orthogonal frequency division multiple access (OFDMA) frames received across a wireless channel; and
determining an enhanced fractional CFO estimate based on the sampled plurality of fractional CFO estimates.

15. The computer-readable medium of claim 14, the operations further comprising:
sampling a plurality of carrier-to-interference-plus-noise ratio (CINR) estimates corresponding to the sampled plurality of fractional CFO estimates; and
determining the enhanced fractional CFO estimate based on the sampled plurality of fractional CFO estimates and the corresponding sampled plurality of CINR estimates.

16. The computer-readable medium of claim 15, wherein determining the enhanced fractional CFO estimate comprises selecting one of the sampled plurality of fractional CFO estimates corresponding to the highest CINR estimate of the sampled plurality of CINR estimates.

17. The computer-readable medium of claim 15, wherein determining the enhanced fractional CFO estimate comprises:
selecting a portion of the sampled plurality of fractional CFO estimates corresponding to a portion of the sampled plurality of CINR estimates within a percentage of the highest CINR estimate of the sampled plurality of CINR estimates; and
averaging the selected portion of the sampled plurality of fractional CFO estimates to be the enhanced fractional CFO estimate.

18. The computer-readable medium of claim 14, wherein determining the enhanced fractional CFO estimate comprises:
averaging the sampled plurality of fractional CFO estimates to determine a mean;
selecting a portion of the sampled plurality of fractional CFO estimates within a percentage of the mean; and
averaging the selected portion of the sampled plurality of fractional CFO estimates to be the enhanced fractional CFO estimate.

19. The computer-readable medium of claim 14, wherein sampling the plurality of fractional CFO estimates comprises:
(a) storing one fractional CFO estimate of an OFDM or OFDMA frame to the sampled plurality of fractional CFO estimates per number of OFDM or OFDMA frames in a sampling interval; and
(b) repeating step (a) for a number of sampling intervals in a sampling count.

20. A receiver for wireless communication, comprising:
first sampling logic configured to sample a plurality of fractional carrier frequency offset (CFO) estimates from a plurality of orthogonal frequency-division multiplexing (OFDM) or orthogonal frequency division multiple access (OFDMA) frames received across a wireless channel; and
determination logic configured to determine an enhanced fractional CFO estimate based on the sampled plurality of fractional CFO estimates.

21. The receiver of claim 20, further comprising:
second sampling logic configured to sample a plurality of carrier-to-interference-plus-noise ratio (CINR) estimates corresponding to the sampled plurality of fractional CFO estimates, wherein the determination logic is configured to determine the enhanced fractional CFO estimate based on the sampled plurality of fractional CFO estimates and the corresponding sampled plurality of CINR estimates.

22. The receiver of claim 21, wherein the determination logic is configured to determine the enhanced fractional CFO estimate by selecting one of the sampled plurality of fractional CFO estimates corresponding to the highest CINR estimate of the sampled plurality of CINR estimates

23. The receiver of claim 21, wherein the determination logic is configured to determine the enhanced fractional CFO estimate by:
selecting a portion of the sampled plurality of fractional CFO estimates corresponding to a portion of the sampled plurality of CINR estimates within a percentage of the highest CINR estimate of the sampled plurality of CINR estimates; and
averaging the selected portion of the sampled plurality of fractional CFO estimates to be the enhanced fractional CFO estimate.

24. The receiver of claim 20, wherein the determination logic is configured to determine the enhanced fractional CFO estimate by:
averaging the sampled plurality of fractional CFO estimates to determine a mean;
selecting a portion of the sampled plurality of fractional CFO estimates within a percentage of the mean; and
averaging the selected portion of the sampled plurality of fractional CFO estimates to be the enhanced fractional CFO estimate.

25. The receiver of claim 20, wherein the first sampling logic is configured to sample the plurality of fractional CFO estimates by:
(a) storing one fractional CFO estimate of an OFDM or OFDMA frame to the sampled plurality of fractional CFO estimates per number of OFDM or OFDMA frames in a sampling interval; and
(b) repeating step (a) for a number of sampling intervals in a sampling count.

26. An apparatus for wireless communication, comprising:
means for sampling a plurality of fractional carrier frequency offset (CFO) estimates from a plurality of orthogonal frequency-division multiplexing (OFDM) or orthogonal frequency division multiple access (OFDMA) frames received across a wireless channel; and
means for determining an enhanced fractional CFO estimate based on the sampled plurality of fractional CFO estimates.

27. The apparatus of claim 26, further comprising:
means for sampling a plurality of carrier-to-interference-plus-noise ratio (CINR) estimates corresponding to the sampled plurality of fractional CFO estimates, wherein the means for determining determines the enhanced fractional CFO estimate based on the sampled plurality of fractional CFO estimates and the corresponding sampled plurality of CINR estimates.

28. The apparatus of claim 27, wherein the means for determining determines the enhanced fractional CFO estimate by selecting one of the sampled plurality of fractional CFO estimates corresponding to the highest CINR estimate of the sampled plurality of CINR estimates

29. The apparatus of claim 27, wherein the means for determining determines the enhanced fractional CFO estimate by:
selecting a portion of the sampled plurality of fractional CFO estimates corresponding to a portion of the sampled plurality of CINR estimates within a percentage of the highest CINR estimate of the sampled plurality of CINR estimates; and
averaging the selected portion of the sampled plurality of fractional CFO estimates to be the enhanced fractional CFO estimate.

30. The apparatus of claim 26, wherein the means for determining determines the enhanced fractional CFO estimate by:
averaging the sampled plurality of fractional CFO estimates to determine a mean;
selecting a portion of the sampled plurality of fractional CFO estimates within a percentage of the mean; and
averaging the selected portion of the sampled plurality of fractional CFO estimates to be the enhanced fractional CFO estimate.

31. The apparatus of claim 26, wherein the means for sampling the plurality of fractional CFO estimates samples the plurality of fractional CFO estimates by:
(a) storing one fractional CFO estimate of an OFDM or OFDMA frame to the sampled plurality of fractional CFO estimates per number of OFDM or OFDMA frames in a sampling interval; and
(b) repeating step (a) for a number of sampling intervals in a sampling count.

32. The apparatus of claim 26, further comprising means for adjusting a signal received across the wireless channel based on the enhanced fractional CFO estimate.

33. A mobile device, comprising:
a receiver front end for receiving a signal transmitted via a wireless channel;
first sampling logic configured to sample a plurality of fractional carrier frequency offset (CFO) estimates from a plurality of orthogonal frequency-division multiplexing (OFDM) or orthogonal frequency division multiple access (OFDMA) frames received across the wireless channel; and
determination logic configured to determine an enhanced fractional CFO estimate based on the sampled plurality of fractional CFO estimates.

34. The mobile device of claim 33, further comprising:
second sampling logic configured to sample a plurality of carrier-to-interference-plus-noise ratio (CINR) estimates corresponding to the sampled plurality of fractional CFO estimates, wherein the determination logic is configured to determine the enhanced fractional CFO estimate based on the sampled plurality of fractional CFO estimates and the corresponding sampled plurality of CINR estimates.

35. The mobile device of claim 34, wherein the determination logic is configured to determine the enhanced fractional CFO estimate by selecting one of the sampled plurality of fractional CFO estimates corresponding to the highest CINR estimate of the sampled plurality of CINR estimates

36. The mobile device of claim 34, wherein the determination logic is configured to determine the enhanced fractional CFO estimate by:
selecting a portion of the sampled plurality of fractional CFO estimates corresponding to a portion of the sampled plurality of CINR estimates within a percentage of the highest CINR estimate of the sampled plurality of CINR estimates; and
averaging the selected portion of the sampled plurality of fractional CFO estimates to be the enhanced fractional CFO estimate.

37. The mobile device of claim 33, wherein the determination logic is configured to determine the enhanced fractional CFO estimate by:
averaging the sampled plurality of fractional CFO estimates to determine a mean;
selecting a portion of the sampled plurality of fractional CFO estimates within a percentage of the mean; and
averaging the selected portion of the sampled plurality of fractional CFO estimates to be the enhanced fractional CFO estimate.

38. The mobile device of claim 33, wherein the first sampling logic is configured to sample the plurality of fractional CFO estimates by:
(a) storing one fractional CFO estimate of an OFDM or OFDMA frame to the sampled plurality of fractional CFO estimates per number of OFDM or OFDMA frames in a sampling interval; and
(b) repeating step (a) for a number of sampling intervals in a sampling count.
